(19) United States
(12) Patent Application Publication
(10) Pub. No.: US 2006/0151902 A1
(43) Pub. Date: Jul. 13, 2006

(54) Method and apparatus for producing plant container liners particularly from sphagnum moss

(76) Inventor: Perry Just, Lake Haupiri (NZ)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/509,845

(22) PCT Filed: Mar. 31, 2003
(86) PCT No.: PCT/NZ03/00054

§ 371 Date: Oct. 12, 2005

(30) Foreign Application Priority Data
Mar. 31, 2002 (NZ) 515579

(51) Int. Cl. B27N 3/00

(52) U.S. Cl. 264/37.29; 264/109; 264/232; 264/122; 425/364 R; 425/353

(57) ABSTRACT

A method for forming three dimensional shaped products from particulate sphagnum moss material including: (a) carrying the particulate moss material to a press forming stage on a conveyor including a belt formed of a flexible and resiliently deformable material arranged moved in steps, the press forming stage including a cavity die member positioned beneath the belt of the conveyor and including a shaped die cavity and a co-operating die member positioned above the belt of the conveyor; (b) pressing the section of the belt of the conveyor between the die members and the particulate material thereon into the cavity die member to form a shaped product; and (c) causing the conveyor to step onto deliver fresh particulate material between the die members after each operation of the press forming stage.

### FIELD OF THE INVENTION

This invention relates to a method and apparatus for forming three-dimensional shaped products particularly plant container liners from in particular sphagnum moss. Such liners are useful in lining hanging baskets, especially those baskets in the form of skeletal containers.

### BACKGROUND

Because of its unique water retaining properties, and pleasant appearance as a natural plant substance, sphagnum moss has traditionally been a favoured material for use in conjunction with floral arrangements and related horticultural activities. Sphagnum moss is sold mostly in a dried state but sometimes in a wet state, generally in a natural loose form. Sphagnum moss is commonly used to line hanging baskets. One reason for this is its particular ability to absorb and retain water up to and exceeding twenty times its own weight. Another is its natural and aesthetically pleasing appearance.

The most common traditional method of using sphagnum moss to line a hanging basket is to place some loose moss in the bottom of the wire basket, then cover the moss with a little potting mix—the basket is gradually filled, by building up the outer layer of sphagnum moss around the outside of the basket and by holding it in place with a little more soil and potting mix. This is repeated several times until the lining of sphagnum moss reaches toward the upper rim of the hanging basket. This method is labour intensive, and is mostly performed at home by the enthusiastic gardener, and sometimes by staff in garden centres. In this form, baskets with a lining layer of sphagnum moss can be made available only when they are filled with soil and potting mix, because it is the soil and potting mix which holds the outer lining of loose filaments of moss in place. There is a limited scope for selling sphagnum moss lined hanging baskets in this form. The labour content in filling them is high. In addition, transporting baskets in this form from one location to another can be very difficult and costly. Thus sphagnum lined hanging baskets filled in this way for sale would normally have to be made and sold in the same garden centre. They are impractical to manufacture on a large scale using technology and production machinery, and then transport in bulk nationally and internationally to many retail outlets.

One company in the USA has created a moss lined hanging basket which can much more readily be transported in cartons as freight, or even posted in the mail, which makes them much more marketable. The short filaments of loose moss are fixed onto the outside of the basket with very fine filament or wire—much like fishing net. Soil or potting mix is not required to hold the moss in place. However the process of sewing the filaments or moss onto the outside of the basket is also time consuming and such moss lined basket are essentially hand crafted items.

Through the use of heavy pressure dry particulate sphagnum moss can be compressed into flat sheets that bind together due to the fiberous nature of this species of moss. The long filaments of New Zealand, Chilean and Tasmanian sphagnum moss are ideal for pressing. The sheets of compressed sphagnum moss are of various thickness, usually from 2 or 3 mm to about 7 mm. However the compressed dry, flat sheets are very brittle and crack easily. They are somewhat like balsa wood in terms of flexibility and they look somewhat like particle board in texture. In New Zealand, one company markets a compressed sphagnum moss product which when unfolded is shaped like a Maltese cross. This item is sold in flat configuration. The moss is so brittle in its compressed state that to protect it from damage when offered for sale, each liner must be protected by either first wrapping the liner in plastic then placing each liner inside a strong cardboard package or outer to protect the liner, or placing and packaging the liner inside a wire basket and then wrapping/sealing both the basket and the liner in plastic. The flat liner to be placed inside a hanging basket must first be wetted so that it partially reconstitutes, thus allowing it to be unfolded and moulded to fit in and contour to the shape of the basket. Disadvantages of this form of liner include:
the compressed sheet of moss must often be redampened to enable it to be folded before being inserted and sealed in a plastic bag.
initially at least when being used the liner does not readily conform satisfactorily to the shape of the curved handing basket.
where the sections of the Maltese cross shaped liner meet, the edges do not overlap nor are they fixed together, and therefore, during the initial period in particular, the soil will often fall through the spaces between the sections in a manner unacceptable for the end user.

In addition, market research shows that consumers often have difficulty in comprehending that the flat dry particle board-like product is actually a moss liner, and in determining how much water should be applied so that the liner can be made flexible:—too much water and the liner will fall apart, and too little water and the brittle liner will crack allowing soil to fall through the liner basket), the liner must often be further wetted to allow holes to be made for plants to be inserted.

U.S. Pat. No. 3,958,365 discloses a method for moulding tubs or pots from fibrous material which includes forming the fibres into a web and spraying the web with an emulsion before optionally moulding sections of the web into tubs or pots with a plunger-type mould.

PCT international patent application publications WO 00/32392 and WO 02/39806 and Australian patent application 87306/01 disclose forming plant container liners by forming flat blanks from sphagnum moss which are subsequently folded to form the three dimensional liners.

### SUMMARY OF INVENTION

It is an object of the present invention to provide a method and apparatus for directly moulding such three dimensional planter liners from sphagnum moss.

In broad terms in one aspect the invention comprises apparatus for forming three dimensional shaped products from particulate sphagnum moss material including co-operating first and second die members arranged to move from an open configuration to a closed configuration to press form three dimensional shaped products from the particulate material, and a resiliently deformable web extending between the die members for carrying the particulate material thereon which will deform between the die members on each closing of the die members to allow the die members to press the particulate material to the three dimensional shape of the product.

Typically the die members include a cavity die part and a plunger die part arranged to press the particulate material on the deformable web into the cavity die part.

In broad terms in another aspect the invention comprises apparatus for forming three dimensional shaped products from particulate sphagnum moss material including:

a conveyor including a belt formed of a flexible and resiliently deformable material and arranged to carry on the belt of the conveyor the particulate material and arranged to move in steps, and

a press forming stage including a cavity die member positioned beneath the belt of the conveyor and including a shaped die cavity, and a co-operating die member positioned above the belt of the conveyor and arranged to move after each step forward of the conveyor which delivers fresh particulate moss material between the die members, to press the section of the belt of the conveyor between the die members and the particulate material thereon into the cavity die member, to form a shaped product.

Preferably the belt of the conveyor has sufficient resilience to lift the press formed product from the cavity die member after each operation of the press forming stage.

Preferably the apparatus includes means for continuously delivering particulate moss material onto the conveyor for conveying to the press forming stage and the conveyor is arranged to convey the formed products away from the press forming stage.

In broad terms in another aspect the invention comprises a method for forming three dimensional shaped products from particulate sphagnum moss material including providing co-operating first and second dies, carrying the particulate moss material on a resiliently deformable web extending between the die members, causing the die members to move from an open configuration to a closed configuration to press between the die members the resiliently deformable web and the particulate moss material thereon to the three dimensional shape of the product, and returning the die members to the open position to release the press-formed product.

In broad terms in a further aspect the invention comprises a method for forming three dimensional shaped products from particulate sphagnum moss material including:

carrying the particulate moss material to a press forming stage on a conveyor including a belt formed of a flexible and resiliently deformable material and arranged to move in steps, the press forming stage including a cavity die member positioned beneath the belt of the conveyor and including a shaped die cavity and a co-operating die member positioned above the belt of the conveyor, to press the section of the belt of the conveyor between the die members and the particulate material thereon into the cavity die member to form a shaped product, and

after each operation of the press forming stage causing the conveyor to step onto deliver fresh particulate material between the die members.

Preferably the particulate matter is moulded at a pressure of at least about 3000 psi.

Preferably the sphagnum moss is prepared prior to pressing so as to be substantially dry, yet slightly moist in a layer which is suitably thick. The preferred moisture level is 14-18% by weight and the preferred thickness is 130-150 mm. The thickness and moisture levels of the moss may be controlled so that the resulting three dimensional liner is made flexible and is not a brittle sheet.

The invention also includes three dimensional shaped items formed by the method and apparatus set out above.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred forms of the invention are described by way of example with reference to the accompanying drawings in which:

FIG. 1 shows filaments of harvested sphagnum moss;

FIG. 2 shows sphagnum moss compressed into sheets;

FIG. 3 shows a completed plant container liner made of sphagnum moss;

FIG. 4 shows the liner of FIG. 3 packaged with shrink wrapping;

FIG. 5 shows a number of liners stacked in nested configuration and shrink wrapped;

FIG. 6 shows the completed plant container liner in a hanging basket;

FIG. 7 is a part cross-section view of one form of apparatus for forming plant container liners of the invention;

FIG. 8 is a plan view of the flexible material on which the moss or other particulate material is supported in use of the apparatus of FIG. 7;

FIG. 9 is a schematic side view of another form of apparatus of the invention for automated production of liners;

FIG. 10 is a view of the machine of FIG. 9 in the direction of arrow I in FIG. 9;

FIG. 11 is a view of part of the machine of FIG. 9 in the direction of arrow II in FIG. 9;

FIGS. 12a to 12d show a single operation of the moulding stage of the machine of FIG. 9 in steps;

FIG. 13 shows a preferred form of construction of the moulding stage;

FIGS. 14 to 24 show different forms of sphagnum moss plant container liners which may be formed by the method and apparatus of the invention and their use; and

FIGS. 25 to 28 show plunger and cavity die parts for forming a wreath liner and the operation thereof

### PREFERRED EMBODIMENTS OF THE INVENTION

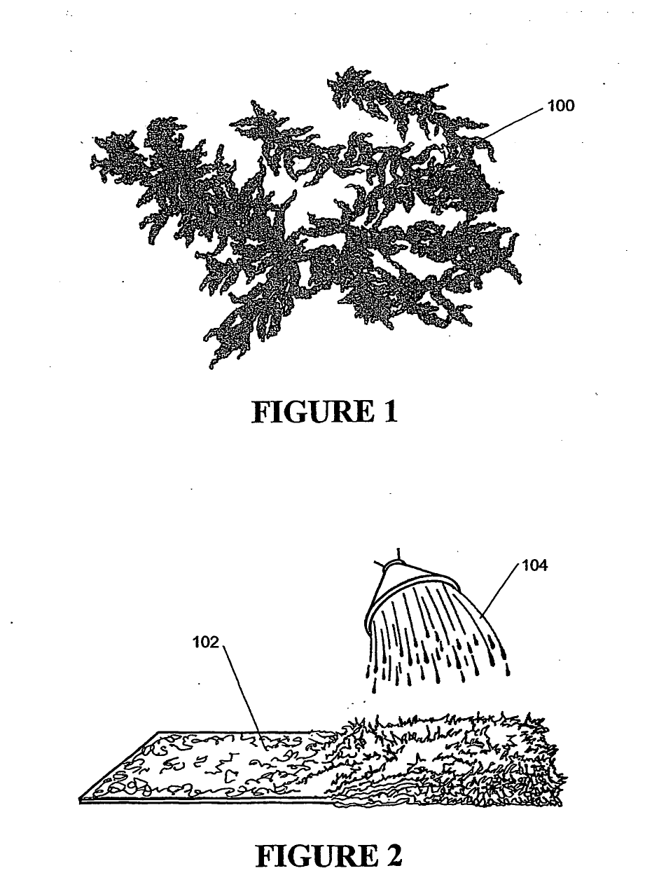

FIG. 1 shows filaments of harvested sphagnum moss 100. According to the Encyclopaedia Britannica, mosses are usually classified into three orders: Sphagnales, Andreaeales and Bryales. The order Sphagnales has a single genus sphagnum, and is often the chief component of peat bogs and is usually known as bog or peat mosses. We prefer to use sphagnum moss, but any suitable moss may be utilised. There are approximately 14 000 species of all types of moss throughout the world, whereas there are only approximately 300 species of sphagnum moss (Colliers Encyclopaedia 16 “Moss”, “18 Peat Moss” 1966). It is believed there are 5 species of sphagnum moss found on the West Coast of New Zealand's South island. These are Sphagnum Falcatulum, Sphagnum Subnitens, Sphagnu Christatum, Sphagnum Australe, Sphagnum Subsecundum. Any of these species alone or in combination may be used in our liners. Furthermore, moss from Chile, Sphagnum Magellanicum, is also particularly appropriate for forming liners. Sphagnum moss is recognised in the market as greatly superior to other types of moss in its water retention properties, being able to absorb up to twenty times its own mass of water. Largely because of its absorbency, it has been used as packing for nursery stock and cut flowers, for surgical dressing, as an additive to soil and as litter for stables and chicken houses. Because so many of the cells in the leaves and stems are large, empty and have porous walls, sphagnum can absorb tremendous quantities of liquids and odours. In addition, the plant contains a small amount of sphagnol, a phenolic compound with some antiseptic properties. (Encyclopaedia Britannica 15 “Moss” 1963).

The sphagnum moss we use has long scaly strands, with relatively large leaves, which have the property that when dried and compressed using our process, the leaves and stems interlock in a flexible structure that retains its shape and is self-supporting without the use of glues or other supporting materials, and is still easily recognisable as moss. The sphagnum moss 100 is also used for its aesthetic value in hanging basket arrangements. The sphagnum moss is harvested from a natural and renewable source. Preferably about 40% of the sphagnum moss has strands exceeding 75 mm in length.

Initially excess water may be removed from the freshly harvested sphagnum moss 100 through the use of a centrifuge or calendar rolls. The sphagnum moss is then dried, either in a kiln for example or with natural sunlight. Preferably, the sphagnum moss if kiln dried is passed through a drying tunnel on a continuous conveyor, the speed of which is controllable to control the drying time. Suitably, an automatic feeding system (not shown) that deposits the moss onto the conveyor is also provided, such as a hopper into which moss is loaded and from which moss is deposited from an outlet onto the conveyor. The kiln may be in the form of a tunnel within which heated air is circulated, which may be generated from hot water heat exchangers operating at a temperature as high as 140° C. The moss is gradually dried as it travels through the kiln.

After drying, the moss may be left in piles to cool and reabsorb some moisture from the atmosphere. Optionally, additional moisture is then added to recondition the moss, through pressurised water misting nozzles for example. The desired amount of water added may be between 0.014 gm of water per cm² of moss liner sheet and 0.070 gm of water per cm² of moss liner sheet. Re-conditioning may be carried out over a 24 hour period and enables the moss to become supple and flexible. The optimum moisture content of the moss prior to pressing is 14 to 18 percent by weight, or less preferably.

After drying and re-conditioning the sphagnum moss is more readily able to be compressed into sheets 102 as illustrated in FIG. 2. The sphagnum moss sheet has the ability to absorb a significant quantity of water 104 and reconstitute into its substantially original state. The sheet 102 illustrated in FIG. 2 is included to illustrate the ability of sphagnum moss to reconstitute from a compressed, substantially dried state to its substantially original state. In the present invention however, the sphagnum moss is shaped into a three dimensional product and thus FIG. 2 is provided only to aid understanding of the properties of sphagnum moss.

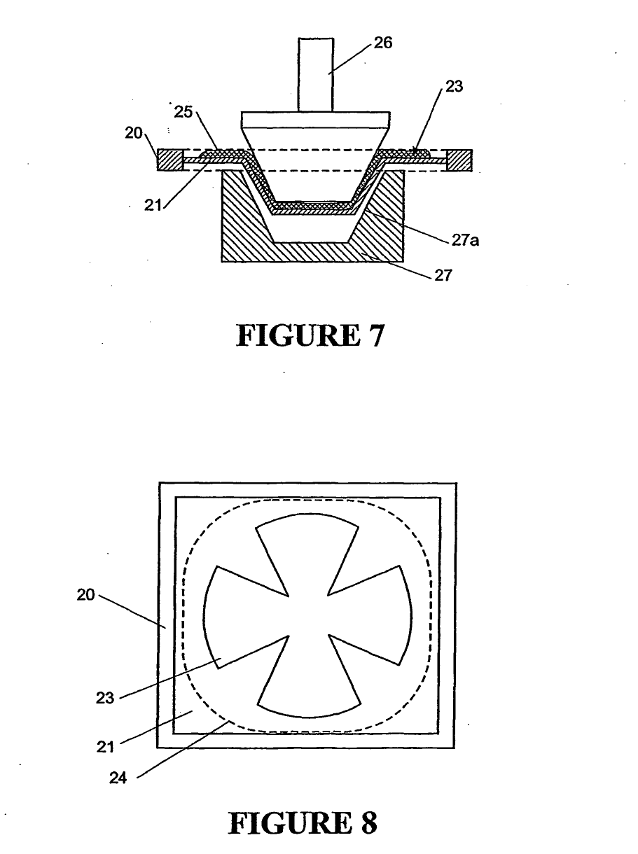

FIG. 7 shows a simple form of apparatus used to form liners in accordance with the invention. The apparatus comprises a cavity die member 27 having a die cavity 27a The die cavity 27a has the three dimensional external shape of the product. The apparatus includes a plunger die member 26 which is reciprocally moveable into and from the cavity die member 27. In FIG. 7 the plunger die member is shown part way through its downward movement into the cavity die member 27. In its upper most position the plunger die member 26 is withdrawn fully and clear of the web 21/23. In the form shown a frame 20 supports a section of flexible material 21/23 between the plunger die member 26 and the cavity die member 27.

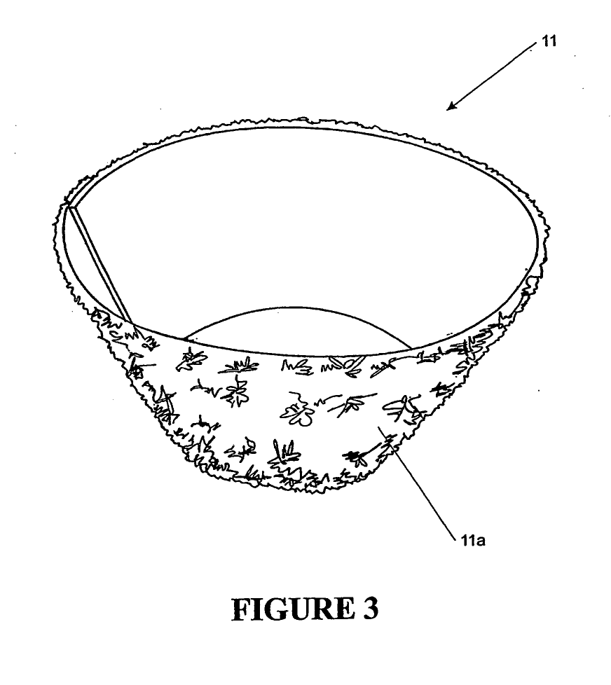

Optionally for forming a liner of the shape shown in FIG. 3 and referring to FIG. 8, the flexible material 21/23 in one form may optionally have a central portion 23 in the shape of a Maltese cross as shown of substantially non-stretchable material such as cotton drill, surrounded by an outer portion of stretchable material such as a Lycra™ based material. The edges between the central portion 23 and the outer portion 21 may be stitched together.

In use moss 25 is spread over the flexible material 21/23 either before or after placing between the plunger and cavity die members, preferably within the confines of the dotted line 24 in FIG. 8. For example, for a liner having a diameter of 35 cm and a depth of 16 cm, about 135 gms of sphagnum moss is used.

During operation the plunger die member 26 initially makes contact with the sphagnum moss 25 in the centre of the flexible material 21/23. As the plunger die member moves further the moss beneath the base of the plunger die member 26 is trapped between the plunger die member and the flexible web, and as the plunger die member 26 continues to move downwardly the sphagnum moss on the flexible web is caught between the tapered sides of the plunger die member 26 and the flexible web, and is pushed to shape into the die cavity 27a with a substantially even thickness of the moss. Moss accumulating at the base of the mould with an uneven distribution of moss in the finished liner is minimised. Preferably sphagnum moss is moulded at pressures ranging from 3000-4000 psi to bind the strands of sphagnum moss together without adhesives. After the plunger die member 26 has pushed the moss fully into the cavity die member 27, deforming the flexible web to its maximum extent so that the flexible web fully contacts the interior of the cavity die member 27, the plunger die member 26 then fully withdraws. The natural elasticity of the flexible web then tends to lift the moulded product from within the cavity die member 27. The moulded liner is removed, and the process can be repeated. After moulding, the annular lip of the liner may be trimmed as necessary.

Optionally, the peripheral rim of the die cavity 27b may include an annular recess so that a reduced degree of compression is applied to the moss in this area. The upper periphery of the resulting liner will then be less pressed and will retain some of the characteristics of unpressed moss, making the composition of the product more easily recognisable by potential customers. The depth of such a peripheral rim portion may be 2.5-3.5 cm for example.

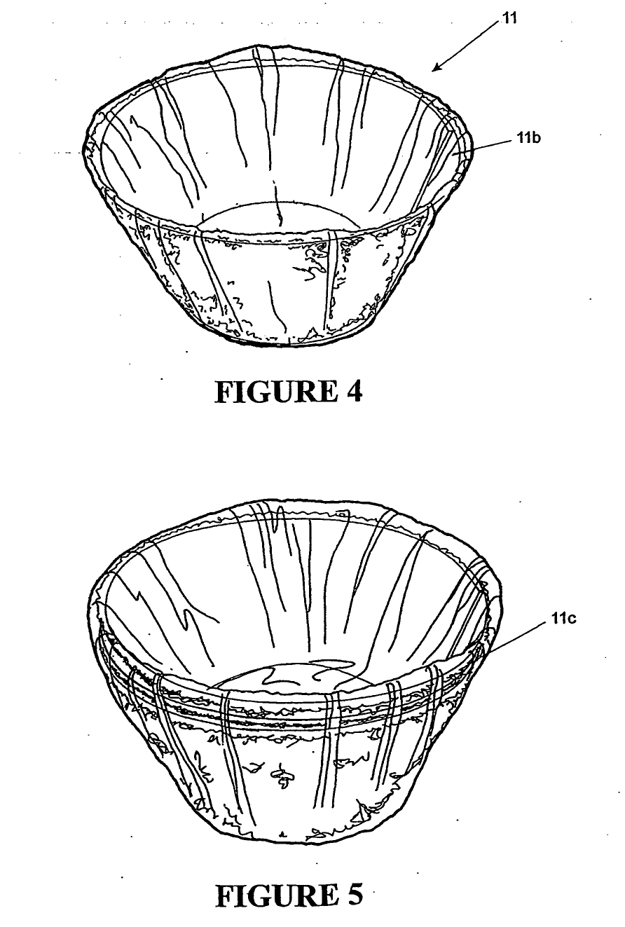

The exterior of the compressed sphagnum moss liner typically has the appearance of cardboard and may not be easily recognisable to the purchasing public as a sphagnum moss liner. To bring the surface of the sphagnum moss liner to more closely resemble the original natural state of sphagnum moss, a fine mist of water may be optionally sprayed onto the exterior of the liner using an atomised fluid spray. The amount of water applied may for example be about 113-173 g/m², preferably 143 g/m². The temperature of the water is also preferably between 15-25° C. The resulting liner will then resemble that illustrated in FIG. 3 with the exterior surface 11a of the liner reconstituted as illustrated. The degree of reconstitution may also enable the liner to be pliable to the extent that it can be folded and unfolded with minimal or no degradation of the fibre integrity and yet enables the walls of the liners to be sufficiently rigid as to be self-supporting. To then prevent drying out, the liners are preferably enclosed in a sealed package as shown in FIGS. 4 and 5. Following moulding and partial reconstitution but before packaging, the liners 11 may optionally have appropriate product information and advertising sheets placed in or over the liners 11 in such a manner that they contour to the curved surfaces of the liners 11.

FIG. 4 shows a liner enclosed within a bag 11b of shrink wrap plastic. The bag is sealed in a circular shape around the top of the liner 11, 10 to 100 mm from the top edge with a purpose built circular sealing machine. This provides a surplus of plastic which fits down inside the internal sides and the bottom of the liner. The plastic may during heat shrinking be temporarily held in position against the sides and bottom of the liner 11 with a weighted wire frame which conforms to the inner shape of the liner. As the wire frame (not shown) is inserted into holes punched into the plastic prior to sealing enable air trapped inside the bag to escape. The liner in the sealed bag and with the weighted wire frame is passed through a heat shrink oven or tunnel a conveyor, preferably on a conveyor, after which the wire frame is removed. The result is that the plastic still lies snug against the interior and the bottom of the liner (and is not stretched tightly across the open top of the liner as would occur in conventional shrink wrapping). The use of a circular bag with a circular sealer also eliminates bunching of the plastic on the outside of the liner that would occur with the use of a square bag. Two or more liners may be nested together and shrink wrapped as shown in FIG. 5 and the shrink wrapping tends to compact the liners more tightly together than prior to wrapping. This enables more multi-product packs to fit into a cardboard carton than a single shrink wrapped package.

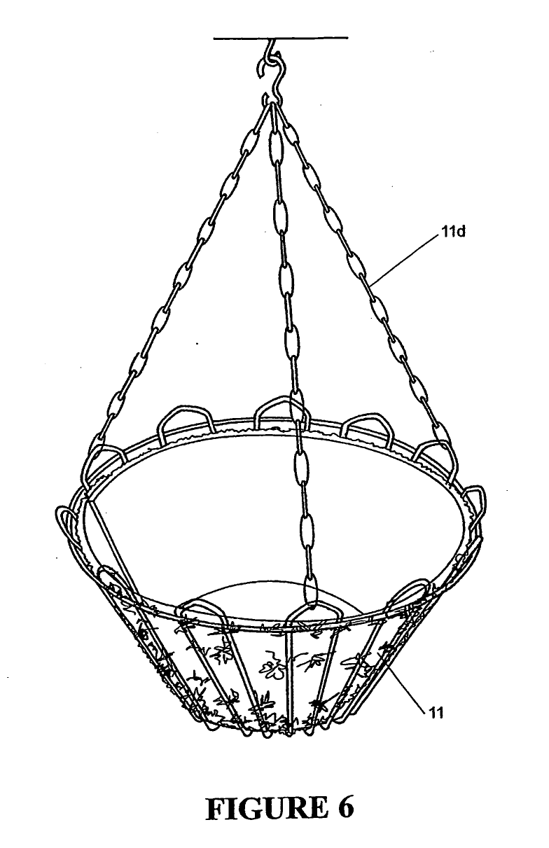

Use of a liner is shown in FIG. 6. The liner 11 is inserted into a conventional hanging basket assembly 11d. Once the liner 11 is inserted into the basket, it may be fully reconstituted by having water poured over or by being soaked in water to cause full reconstitution of the moss to its natural state.

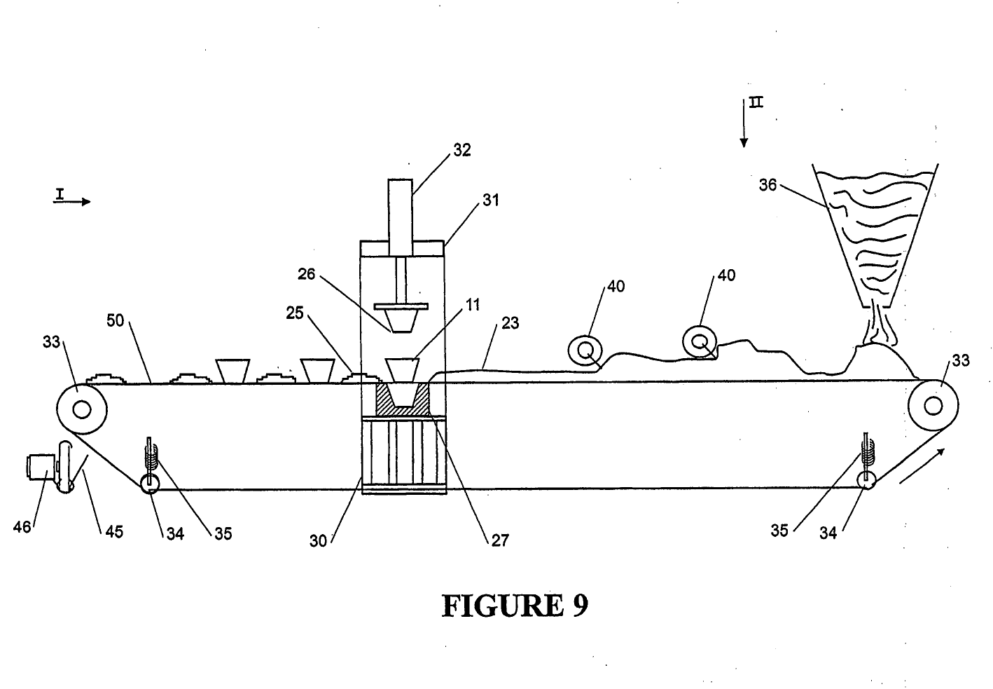

FIGS. 9 to 13 show operation of an automated system for producing moss liners. In these figures similar reference numerals as in FIG. 7 indicate similar components A cavity die member 27 is mounted on abed 30, and a plunger die member 26 is carried by an overhead frame 31. Movement of the die member 26 is controlled by a pneumatic or hydraulic ram 32 carried by overhead frame 31, or other suitable drive mechanism. A stepper conveyor carries loose, dry moss to and formed liners away from the moulding stage. The belt 50 of the conveyor passes around rollers 33, one or both of which may for example be a drive roller including an associated stepper motor or drive system, and subsidiary rollers 34 which in the preferred form include an associated tensioning mechanism 35 for maintaining tension in the belt. Moss is deposited on the forward end of the conveyor and is carried by the conveyor belt which passes continuously between the cavity and plunger die members 27 and 26 of the moulding stage. The belt is formed of a flexible web material. The plunger die member 26 operates repeatedly as the belt moves, on each operation forming a moulded product.

Operation of the mould is similar in principle to that of FIG. 7. On each operation a section of the flexible conveyor belt 50 carrying a layer of moss material is pushed and deformed into the cavity mould member 27 by the plunger die 26. As the die member 26 subsequently withdraws, the belt returns to its normal planar configuration, removing the formed liner from the mould cavity as it does so. The conveyor steps forward moving the liner formed immediately before away from the moulding stage, and bringing fresh moss material into the moulding stage and after each conveyor step the plunger die member 26 moves to form the next liner. Stepped operation of the conveyor via a stepper drive system and of the plunger die member 26 via the ram 32 or similar are synchronized and controlled by a control system for the machine.

Moss may be deposited on the forward end of the conveyor from for example a hopper 36 which extends transversely across the forward end of the conveyor as shown, or by any other suitable moss delivery system. Moss may be deposited on the conveyor at a rate such that the layer of moss formed on the conveyor and carried to the die is of the desired thickness for forming liners. Alternatively as shown moss may be loosely deposited in bulk and then reduced by leveling drums 40 and 41. FIG. 11 shows leveling drum 41 from above. The leveling drum 40 reduces the layer of moss deposited on the forward end of the conveyor in thickness and also spreads the moss across the width of the conveyor. Leveling drums or equivalent may be in any suitable form but in a preferred form each carry a row of stiff fingers 42 as shown. In a preferred form each finger is about 150 mm in radial length, and there is a gap of about 50 mm between adjacent fingers. The leveling drums 40 and 41 reciprocate back and forth about their axes, through an angle of about 90 degrees, and also move transversely back and forth across the conveyor, to spread the moss across the conveyor to form a continuous layer of loose moss of relatively even thickness on the conveyor, which is continuously carried to the moulding stage. Preferably the leveling drums or equivalent are mounted such that their height relative to the top run of the conveyor belt 50 is adjustable, to enable the thickness of the layer of moss carried to the moulding stage to be varied for different shapes and sizes of products.

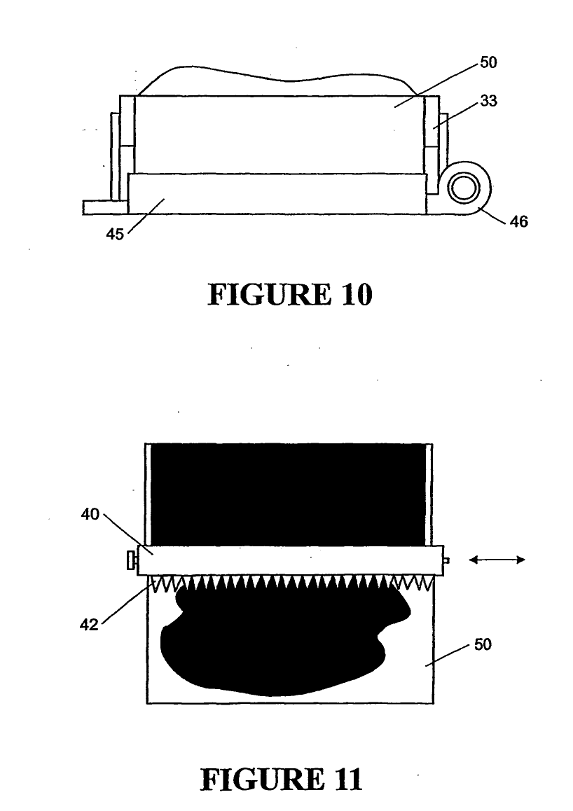

After the moulding stage unused moss 25 between formed liners is carried away and falls from the end of the conveyor to be recycled. Unused moss may fall to trough 45 extending across the end of the conveyor as shown particularly in FIG. 10, from which moss is carried by blower 46 via a pipe or duct back for recycling, to the hopper 36 for example. In an alternative form moss may be initially deposited on the forward end of the conveyor in batches synchronized with the stepping operation of the conveyor and operation of the moulding stage, so that substantially all deposited moss is used to form a liner and negligible moss remains between formed liners after the moulding stage.

We have found suitable materials for forming the conveyor belt to be mock leno fabrics made from spun nylon thread, but the belt may be formed of any suitably flexible and deformable material, which will resiliently return to its original flat form after each pressing, preferably without creasing. The belt material should also be sufficiently tough and durable to withstand the regular deformation of the moulding stage. Preferably the nature of the belt material is also such that when it is deformed to conform to the interior shape of the mould cavity it will stretch to still provide a smooth surface against which the moss is pressed, substantially without wrinkles or folds which would form an impression in the formed moss liner, which may constitute lines of weakness in the product.

The tensioners 35 or equivalent should maintain tension in the conveyor belt so that the belt will automatically spring from the cavity mould 27 as the plunger die part 26 withdraws, to lift the product from the mould, but also so as to allow sufficient “give” in the continuous belt that the belt can be pressed into the mould on each operation without tearing of the belt.

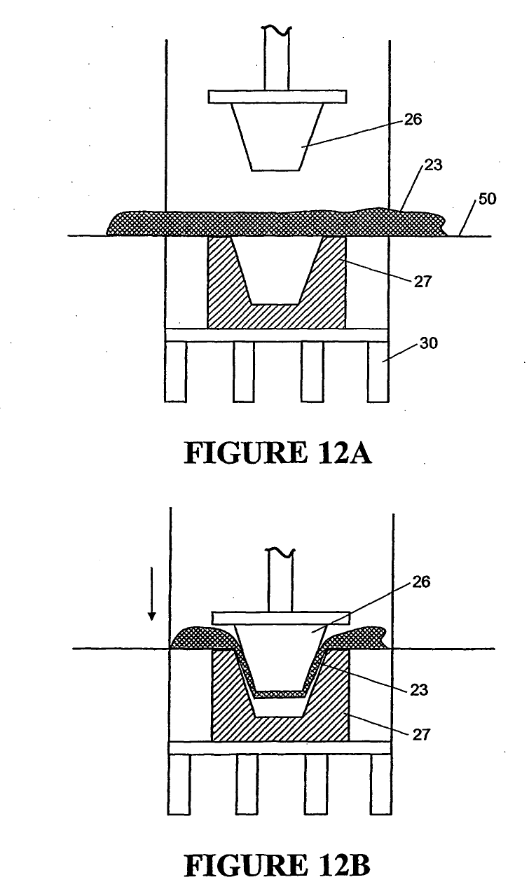

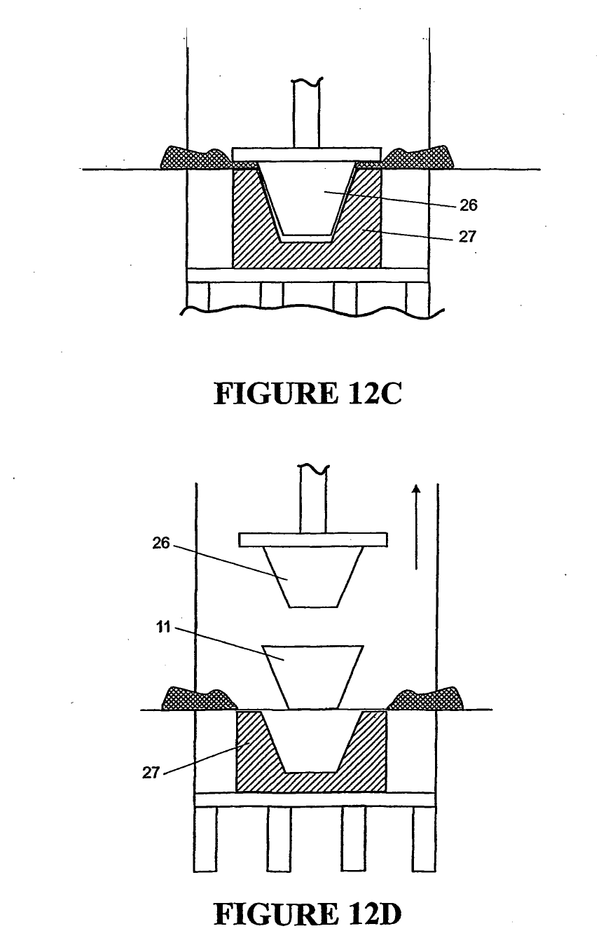

FIGS. 12A to 12D show a single operation of the moulding stage in steps. Initially after the plunger die part 26 has withdrawn from within the cavity die part 27 after the last operation of the moulding stage, the conveyor steps forward to bring a fresh layer of moss between the die parts 26 and 27 as shown in FIG. 12A. The plunger die part 26 is then caused to move downwardly to press the moss into the die cavity 27, deforming the conveyor belt 50 as it does so as shown in FIG. 12B, until the plunger die part 26 is fully home as shown in FIG. 12C. The plunger die part 26 then withdraws, allowing the section of the belt pushed into the die cavity 27 to return to its normal configuration, carrying the formed liner from the die cavity as it does so. The conveyor then steps forward, carrying the formed liner away from the mould, and fresh moss on the conveyor to between the die parts 26 and 27 for the next operation.

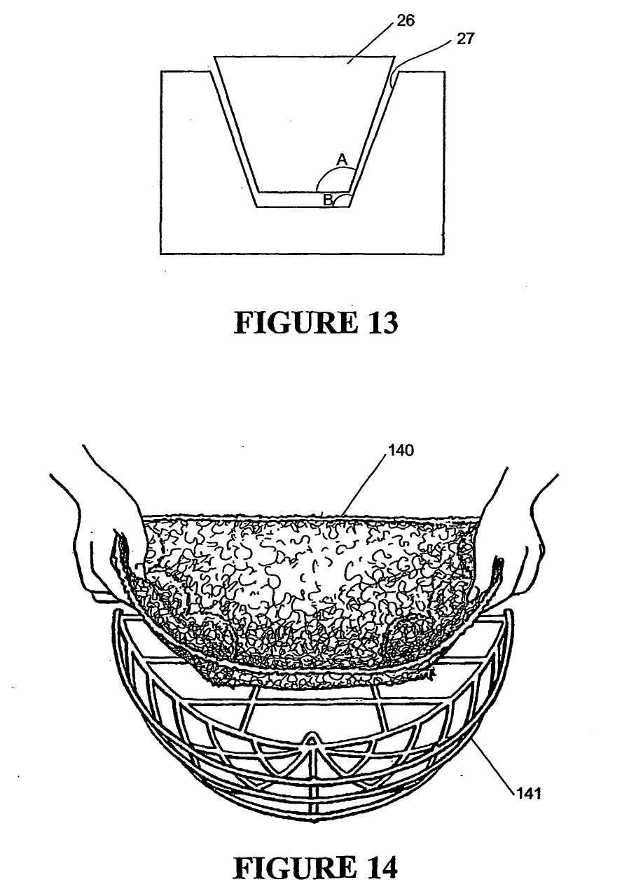

Referring in particular to FIG. 13 it has been found preferable that the angle of the sides of the plunger die part 26 is slightly steeper than the corresponding angle of the sides of the die cavity 27b. That is, preferably that angle A shown in FIG. 13 is slightly less than angle B, so that when the plunger die part 26 is at the end of its travel within the cavity die part 27, there is an even spacing at all points between the bottom and sides of the plunger die part 26 and the bottom and interior sides of the die cavity 27. This difference may be about 3 mm in 400 mm up the sides of each die part. If angle A is the same as angle B, then when the die part 26 is fully home there can still be a small gap between the die parts 26 and 27 at the bottom of the mould, but no space between the die parts at the top of the sides of the mould.

The moulding stage may comprise a single plunger and cavity die pair, or alternatively for higher production a number of adjacent plunger and cavity die pairs across the conveyor which operate to produce a multiple number of products at each operation and step of the conveyor. For production flexibility, in a most preferred form the plunger and cavity die parts 26 and 27 are removable so that for example in a machine arranged to form three basket liners simultaneously on each operation of the moulding stage and step of the conveyor, the three plunger die parts 26 and cavity die parts 27 may be removed and replaced with a single longer plunger die part which is carried across the conveyor by the three spaced rams 32 and operates into a single longer transverse cavity die part 27, for forming hayrack liners for example.

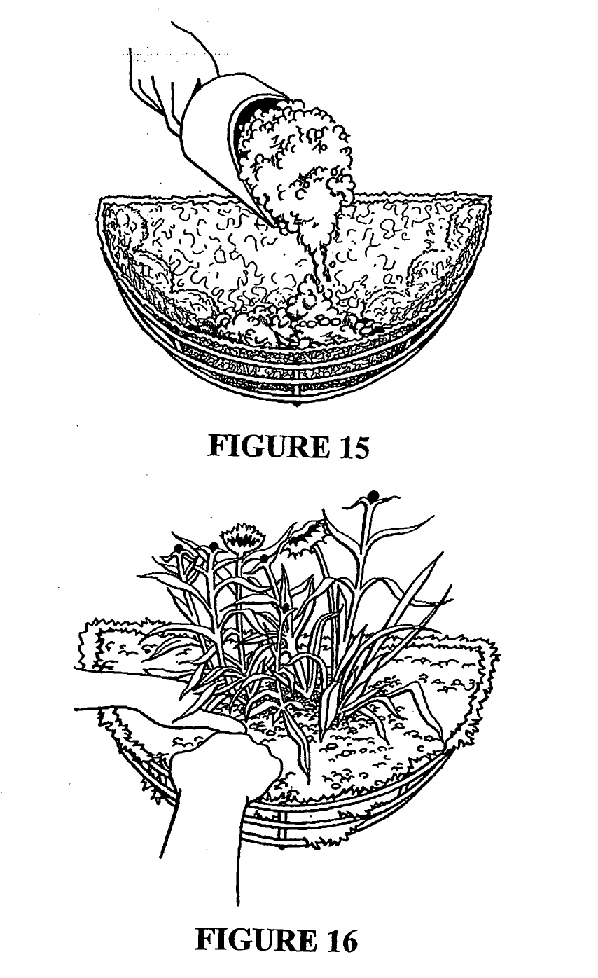

FIG. 3 shows a basket liner formed from sphagnum moss by the method of the invention. The plunger and cavity die parts 26 and 27 of the moulding stage may be appropriately shaped for forming other products, such as the wall basket sphagnum moss liner 140 shown being placed after unwrapping into a wire wall basket 141 in FIG. 14. After the liner has been placed into the basket, it is filled with soil as shown in FIG. 15 and may then be planted as shown in FIG. 16.

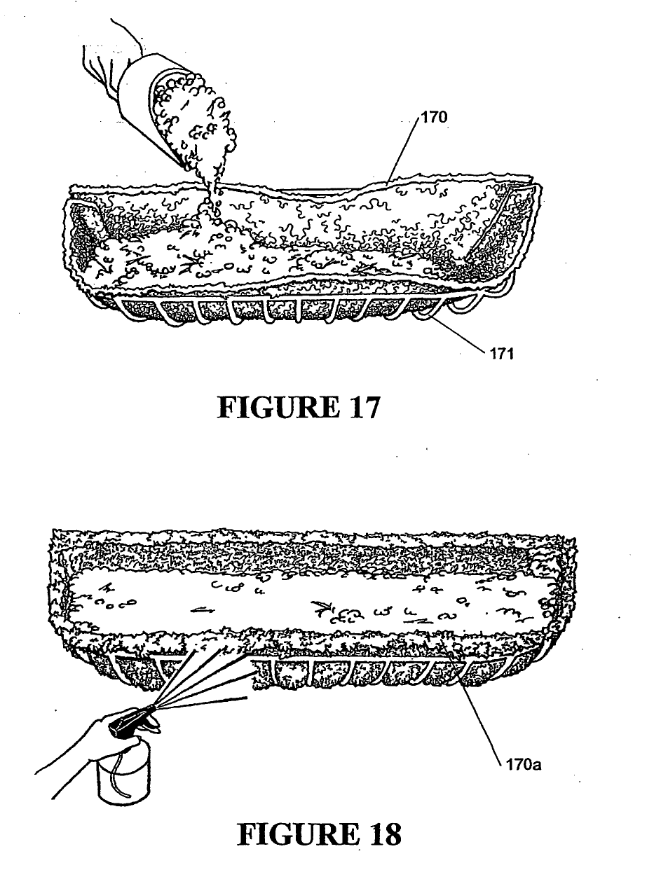

FIG. 17 shows a hayrack sphagnum moss liner 170 for a hayrack basket 171 being filled with soil. Hayrack liners or other products which are longer than they are deep may also be formed with appropriately shaped die parts, which extend across the conveyor for example. FIG. 18 shows spraying of the exterior of the liner with water after it has been placed in a wire basket and filled with soil, to reconstitute the exterior and its aesthetic moss appearance. The hayrack liner shown has also been formed where the upper peripheral part of the liner is less compressed during forming, so that it has a fluffy or natural moss-like external appearance to the upper peripheral edge 170a even before reconstitution after unwrapping, as shown.

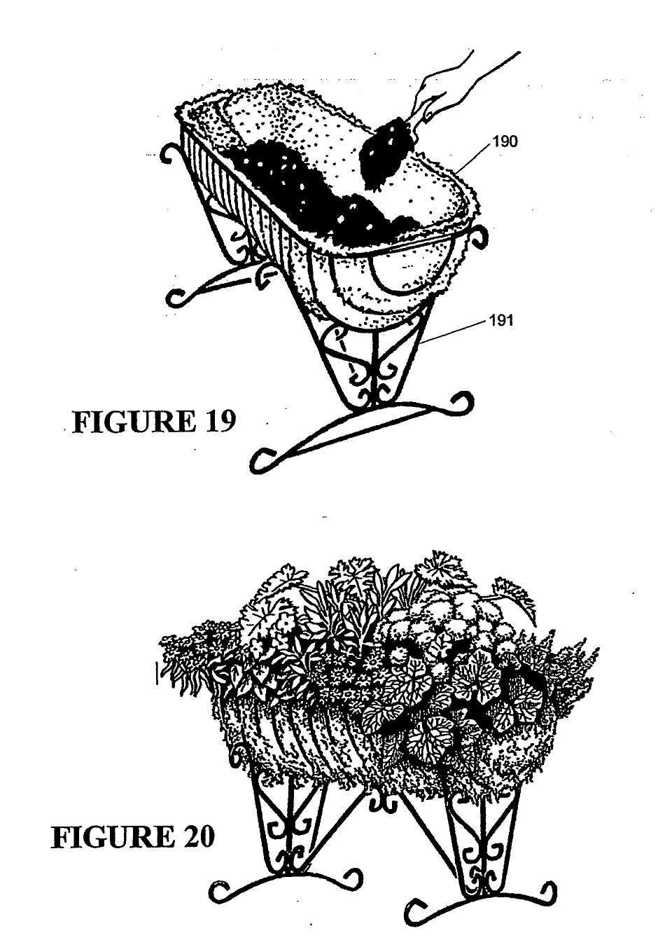

FIGS. 19 and 20 show a liner 190 for a cradle planter formed by the apparatus and method of the invention, in a wire cradle planter 191, and being filled with soil in FIG. 19 and after planting in FIG. 20.

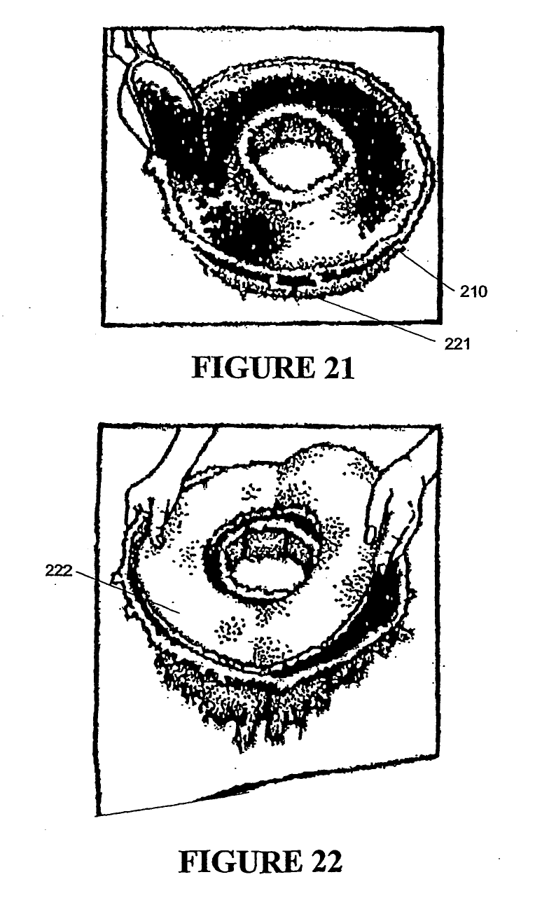

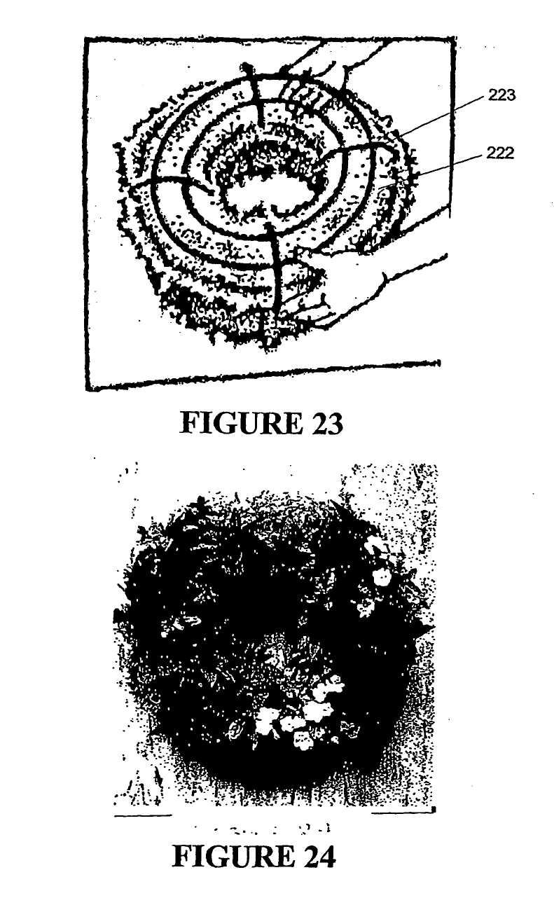

The method and apparatus of the invention may also be used for forming sphagnum moss wreaths. Referring to FIGS. 21 to 23 a wreath liner 210 is typically placed within a donut shaped wire frame 221, and filled with soil as shown in FIG. 21. A cover part 222 of the moss liner is placed over the soil as shown in FIG. 22 and another part 223 of the wire frame of the wreath is placed on top as shown in FIG. 23. The wreath may then be planted by forming holes through the moss and planting plants into the soil through the holes, to form the finished wreath which may for example be hung as shown in FIG. 24.

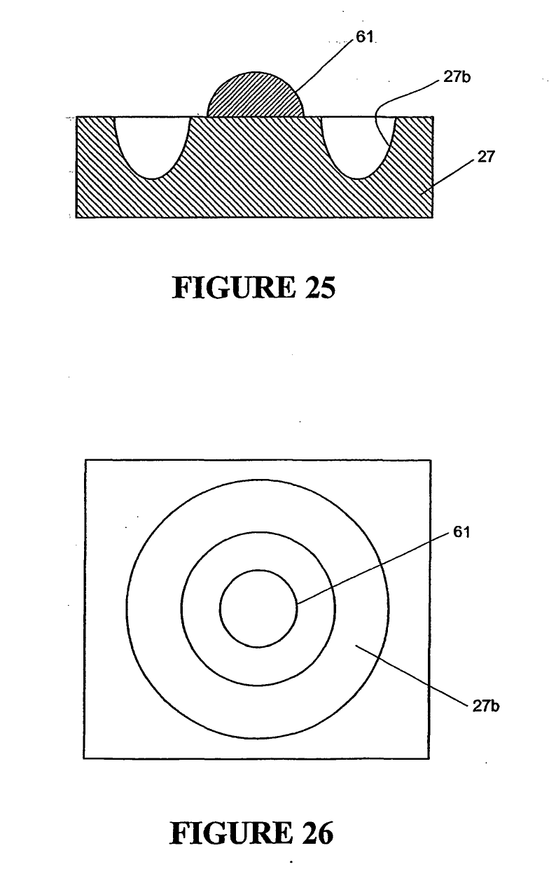

FIGS. 25 to 28 show how a wreath moss liner may be formed by the method of the invention. A cavity die part 27 (carried on bed 30 in FIG. 9) has an annular cavity 27b. An annular plunger die part 26 carried by a platen 60 is pushed into (by the ram 32 in FIG. 9) die cavity 27b deforming the conveyor belt 50 carrying a layer of moss (not shown), into the annular cavity 27b. After the plunger die part 26 withdraws, the belt 50 lifts the pressed annular liner from the mould cavity as before. Alternatively the die cavity 27 and plunger die part 26 may be shaped to form oval or square wreaths, or part circular shapes or similar for example.

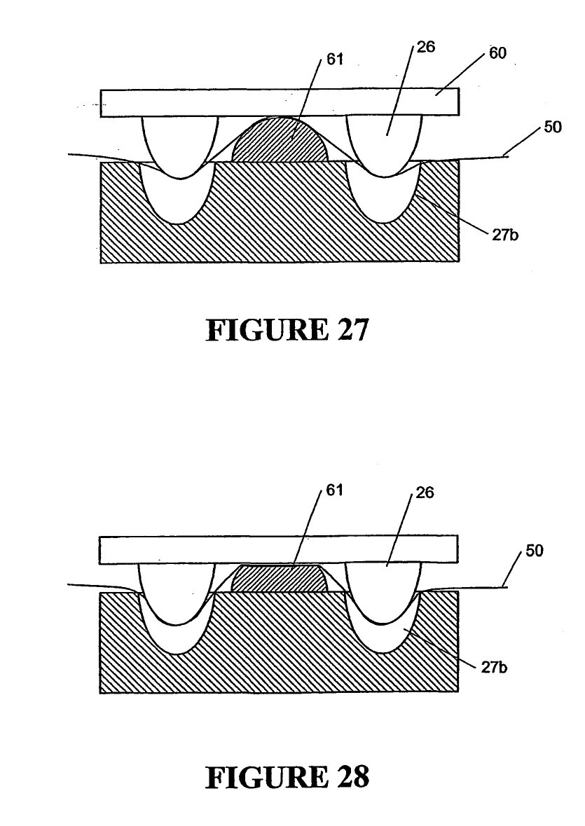

In a preferred form a raised central portion 61 is provided beneath the belt 50 on the mould part 27 as shown, which is preferably formed of a compressible material such as a foam material for example. As shown in FIGS. 27 and 28 this assists in ensuring that the belt deforms to the shape of the interior of the annular mould cavity and protects the belt from damage.

Advantages of the method of the invention include that sphagnum moss liners may be formed without gaps at joins as occur when liners are manufactured as flat blanks which are subsequently folded to shape for use, and in addition the three dimensional shaped liner is immediately recognizable to consumers as a planter liner. Use of the liner requires only unwrapping of the liner (where the product has been packaged for sale) placing it in a wire basket or hayrack or similar and rewetting, and not the more complicated steps of wetting a moss blank to reconstitute it sufficiently to enable it to be folded to shape, but not so much as to

remove all structural integrity of the blank so that it breaks or falls apart on folding, and folding the blank to shape and fitting it within the wire basket

The foregoing describes the invention including preferred forms thereof. Alterations and modifications as will be obvious to those skied in the art are intended to be incorporated within the scope hereof as defined in the accompanying claims.

1. Apparatus for forming three dimensional shaped products from particulate sphagnum moss material comprising:
a conveyor including a belt formed of a flexible and resiliently deformable material and arranged to carry on the belt of the conveyor the particulate material and arranged to move in steps,
means for continuously delivering particulate moss material onto the conveyor for conveying to a press forming stage and a spreader for spreading the particulate material to a substantially even thickness layer on the belt of the conveyor,
a press forming stage including a cavity die member positioned beneath the belt of the conveyor and including a shaped die cavity, and a co-operating die member positioned above the belt of the conveyor and arranged to move after each step forward of the conveyor which delivers fresh particulate moss material between the die members, to press the section of the belt of the conveyor between the die members and the particulate material thereon into the cavity die member, to form a shaped product,
the belt of the conveyor having sufficient resilience to lift the press formed product from the cavity die member after each operation of the press forming stage, and the conveyor being arranged to convey the formed products away from the press forming stage.

2. Apparatus according to claim 1 wherein the spreader comprises one or more longitudinal spreaders each arranged to move reciprocally across the conveyor before the press forming stage and rotate about a longitudinal axis of the spreader and carrying a number of spreader fingers.

3. Apparatus according to claim 1 wherein the belt of the conveyor is formed from a synthetic fabric material.

4. Apparatus according to claim 3 wherein the synthetic fabric material is a woven or knitted synthetic material.

5. Apparatus according to claim 3 wherein the synthetic fabric material is a woven synthetic material.

6. Apparatus according to claim 1 including means after the press forming stage for collecting and recycling unused particulate.

7. Apparatus according to claim 1 including a subsequent packaging stage for shrink packaging each product or numbers of products together.

8. Apparatus according to claim 1 wherein the die members are shaped to form products having a truncated approximately conical shape.

9. Apparatus according to claim 1 wherein the die members are shaped to form products which are wider than they are deep in a plane between a closed base and an open top of the products.

10. Apparatus according to claim 1 wherein the press forming stage comprises two or more pairs of die members for forming two or more products after each step forward of the conveyor which delivers fresh particulate material to the press forming stage.

11. Apparatus according to claim 10 wherein the die members are interchangeable between die members shaped to form smaller products and die members shaped to form products having a dimension greater across the width of the conveyor than in the direction of movement of the conveyor for forming products which are wider than they are deep in a plane between a closed base and an open top of the products.

12. Apparatus according to claim 1 including a drying stage for kiln drying the particulate moss material before depositing on the conveyor for press forming into products.

13. Apparatus according to claim 12 including a rewetting stage for applying moisture to the particulate moss material to re-condition the moss material after drying but before press forming into products.

14. Apparatus according to claim 13 including a subsequent packaging stage for packaging the products.

15. Apparatus according to claim 1 including a stage arranged to apply moisture to the exterior of the products to at least partially reconstitute at least part of the exterior of the products to a natural sphagnum moss appearance, after press forming and a subsequent packaging stage for packaging the products in packaging which minimizes moisture loss from the products.

16. Apparatus according to claim 14 wherein said packaging stage is arranged to heat shrink package the products in a plastic film material.

17. A method for forming three dimensional shaped products from particulate sphagnum moss material comprising:
spreading particulate material to a substantially even thickness layer on the belt of a conveyor,
carrying the particulate moss material to a press forming stage on a conveyor including a belt formed of a flexible and resiliently deformable material and arranged to move in steps, the press forming stage including a cavity die member positioned beneath the belt of the conveyor and including a shaped die cavity and a co-operating die member positioned above the belt of the conveyor, to press the section of the belt of the conveyor between the die members and the particulate material thereon into the cavity die member to form a shaped product, and the belt of the conveyor having sufficient resilience to lift the press-formed product from the cavity die member after each operation of the press forming stage,
causing the conveyor to convey the formed products away from the press forming stage, and
after each operation of the press forming stage causing the conveyor to step on to deliver fresh particulate material between the die members.

18. A method according to claim 17 wherein the belt of the conveyor is formed from a synthetic fabric material.

19. A method according to claim 18 wherein the synthetic fabric material is a woven or knitted synthetic material.

20. A method according to claim 18 wherein the synthetic fabric material is a woven synthetic material.

21. A method according to claim 17 including collecting and recycling unused particulate after the press forming stage.

22. A method according to claim 17 including subsequently packaging each product or numbers of products together.

23. A method according to claim 17 including applying moisture to the exterior of the products to at least partially reconstitute at least part of the exterior of the products to a natural sphagnum moss appearance after press forming, and subsequently packaging the products and packaging which minimizes moisture loss from the products.

24. A method according to claim 22 including heat shrink packaging the products in a plastics film material.

25. A method according to claim 17 wherein the die members are shaped to form products having a truncated approximately conical shape.

26. A method according to claim 17 wherein the die members are shaped to form products which are wider than they are deep in a plane between a closed base and an open top of the products.

27. A method according to claim 17 including press forming two or more products after each step forward of the conveyor which delivers fresh particulate material to the press forming stage, by two or more pairs of die members at the press forming stage.

28. A method according to claim 27 wherein the die members are interchangeable between die members shaped to form smaller products and die members shaped to form products having a dimension greater across the width of the conveyor than in the direction of movement of the conveyor for forming products which are wider than they are deep in a plane between a closed base and an open top of the products.

29. A method according to claim 17 including drying the particulate moss material before depositing on the conveyor for press forming into products.

30. A method according to claim 17 wherein the sphagnum moss is moss of any of the following species, alone or in combination: Sphagnum Falcatulum; Sphagnum Subnitens; Sphagnum Cristatum; Sphagnum Australe; Sphagnum Subsecundum.

31. A three dimensional shaped product produced by the method of claim 17.

32. A three dimensional shaped product which is a plant container liner produced by the method of claim 17.
